(19) United States
(12) Patent Application Publication
(10) Pub. No.: US 2013/0155251 A1
(43) Pub. Date: Jun. 20, 2013

(54) MONITORING SYSTEM ACCOMODATING MULTIPLE IMAGERS

(71) Applicant: Oren Moravchik, Tel-Aviv (IL)

(72) Inventor: Oren Moravchik, Tel-Aviv (IL)

(21) Appl. No.: 13/716,229

(22) Filed: Dec. 17, 2012

Related U.S. Application Data
(60) Provisional application No. 61/576,472, filed on Dec. 16, 2011.

(51) Int. Cl. H04N 17/00

(52) U.S. Cl. CPC H04N 17/002
USPC 348/159

(57) ABSTRACT

System allowing the use of multiple types of imagers for performing monitoring. System allows calibrating an imager holding apparatus in a manner that allows any of a plurality of imagers to be used to perform successful monitoring of the subject.

### CROSS-REFERENCE TO RELATED APPLICATIONS

This application claims priority from Provisional Patent application No. 61/576,472, filed Dec. 16, 2011 entitled “Fitness Machine Monitoring System and Method”, incorporated herein by reference.

### FIELD OF THE INVENTION

The present invention relates to monitoring of activity, such as a fitness exercise, and more particularly to monitoring fitness exercises using imagers, where monitoring could be made with a plurality of imager types

### SUMMARY OF THE INVENTION

Today imagers are very common, and may come in various forms. Most mobile phones are also imager, and also music players, pdas and tablets are also imagers, allowing users to use the imagers for multiple purposes.

Imagers today therefore come with some or most of the components of a monitoring system: processor, communication, database, processing software or hardware.

This allows users to use their imagers for monitoring purposes using their own devices.

However, there's a variety of imagers with many different imager properties: field of view (“FOV”), image resolution, image quality, color separation etc.

It is the objective of this invention to allow calibrating a holding apparatus so that multiple types of imagers could be used with the same apparatus so that they all achieve the same image processing results, without making any change to the holding apparatus.

Embodiments of the present invention overcome the disadvantages of fixed imagers by using the imagers available to the users to perform the image processing and further, by using a single imager to calibrate the holding apparatus so that it would allow a variety of types of imagers to use it for the same purpose.

The advent of mobile phones and other communication devices that include an imager, communication module and a processor, allows the software of the imager to receive from a local or remote memory the data on the types of imagers that are meant to be used, to get their properties and differences from the current imager, to measure the FOV, colors and other details matching the current imager, to deduce the details required for the other supported imagers, to deduce the required setting of the holding apparatus that would match them all, and to upload to the server the details required for easing their processing.

The use of the personal imager of the user also allows the software to keep the raw data used and the processed data created private to the user.

The use of the personal imager of the user also allows connecting to other service providers for improved value. For example transmit the exercise data to a fitness facility instructor or dietitian, transmitting the security information to a security organization, etc.

In one embodiment, a single imager is used.
The person installing the holding apparatus sets the holding apparatus to an approximate position.
They then activate calibrating software.
The software may check which imager is used.
It may learn which other imagers should be supported by getting the data form a local or remote memory, or using an algorithm.
It may determine image processing parameters such as location, lighting, subject colors etc.
It may use any additional sensors such as GPS, clock, accelerometer, to gather data.
It may deduce the necessary imager location and angle relative to the subject according to any or all of algorithm, server data, own data.
It may instruct the user on how to calibrate the holding apparatus so that it matches the required resulting location and angle.
It may inform the user that the process is complete
It may ask the user to affix the holding apparatus so that it doesn't move.
It may save to local or remote memory the image processing parameters such as lighting that were deduced in the calibration process.
It may save on the device any or all of the details for future sending.

### BRIEF DESCRIPTION OF THE DRAWINGS

FIG. 1 illustrates a general embodiment of a monitoring system using multiple types of imagers according to the present invention;

FIG. 2 illustrates a monitoring setup in which different imagers pose different restrictions on the imagers' placing

FIG. 3 illustrates a process diagram of calibrating the imager holding apparatus according to the embodiment of the present invention.

FIG. 4 illustrates a process diagram of using an arbitrary imager with a system according to the embodiment of the system

FIG. 5 illustrates an embodiment of the system used in a fitness facility for monitoring the fitness machines using a plurality of imager types

FIG. 6 illustrates an embodiment of the invention in which the system is used for intruder alert in a hotel room

FIG. 7 illustrates a holding apparatus for MDIs that may be used with the monitoring system

### DETAILED DESCRIPTION OF THE PREFERRED EMBODIMENTS

Various acronyms are used to clarify herein. Definitions are given below.

The term “Imager” may encompass any device that includes one or more visual capturing devices such as a camera, and may also include a processor, communication, memory unit, input method such as keys or a touch screen, output methods such as screen or speakers, and additional elements. The device may be mobile or it may be fixed. It may also be a device to which an imager can be attached. An imager may be a smart-phone, a music player, a personal digital assistant, a security camera and so on.

“subject” Indicates the object that is being monitored. This object may be a human, it may be a living creature, it may be a machine or a number of machines, it may be an area. It may be static or dynamic. The objective of the invention is to use image processing to get data about the subject.

The term “user” is generally used to refer to a user of the imager. The imager may not be owned by the user.

In an embodiment of the invention where the imager is used to monitor workout data, a user may be a fitness trainer, a fitness instructor, a physician, or any person in the fitness facility or related to it.

In an embodiment of the invention where the imager is used to safeguard a hotel room or motel room or any similar temporary stay residence, the user may be a guest at a hotel, or it may be a hotel personnel.

In an embodiment of the invention where the imager is used to analyze a sports event the user may be an athlete, a coach, a spectator, a journalist, and so on.

The term “communication” is generally used to mean any type of communication between components where the connection is e.g. by wire or wireless, and where the connection allows information to be passed from one device to another. This term may be used in a similar fashion as “Connected”, “Data communication”, “server access”, etc. The following are examples of communication schemes: For wireless techniques examples of employable techniques include wi-fi, cellular protocols, infra Red (IR), radio frequency (RF) and so on. As For wired techniques, a standard USB cable or serial cable or any other cable based communication may be used.

The term “Raw Data” is generally used to mean the image or images received from the imager before being processed. The image or images may be generated by a video or still image or any other imager mode.

The term “Processed Data” is generally used to mean the data that is created from the Raw Data and may have additional value to the user.

The term “Remote Data” is generally used to mean the data that is not placed on the imager and may be accessed by the imager through communication. This data may be received by accessing at the time the data is needed or at a different time and saved in the imager memory.

The term “Subject Processing Data” is generally used to mean any data regarding the subject, imager, environment etc. that is used in the various processes of the various embodiments of the invention including but not limited to image processing. This data may be subject properties such as subject dimensions, subject material, subject color etc. It may be imager properties such as FOV, image resolution, video frame rate, processor speed, memory size, imager lens size, communication rate, etc. It may be environment properties such as geographic location, lighting conditions, surrounding objects, weather conditions, languages used, etc.

The term “Image Processing” is generally used to mean the process which may use the Raw Data and may use the Subject Processing Data in order to create Processed Data. Image Processing may be done by software or hardware or user input or other inputs or any combination of the above.

The term “Perform Monitoring” is generally used to mean performing image processing to generate processed data and passing that data to its user, which may be a person or an element in a process such as calibrating the system or using the system.

The term “Processor” is generally used to mean a software or a hardware element, or an element that combines both software and hardware, and that is may use local data from memory or remote data, and that may be capable of performing the image processing or the communication to remote data, or any other element of the various processes used by the various embodiments of the invention.

The term “Holding Apparatus” is generally used to mean any means of holding or positioning the imager so that it can perform monitoring.

The term “Installer” is generally used to mean the entity performing the calibration process using an imager. This entity may be a human or humans or it may be an apparatus containing mechanical or digital components or it may be a computer controlled entity or any combination of the above.

The term “Calibration” is generally used to mean connecting the holding apparatus so that an imager held by it or connected to it or coupled with it will be in a specific location and in a specific angle, in relation to the subject or in relation to another object or according to both.

The term “Locking” or “securing” is generally used to mean making some of the holding apparatus' properties fixed. For example the holding apparatus may be fixed to a specific location on the floor or the imager angle may be fixed or the extension object of the holding apparatus may be of a fixed length.

The term “Supported Imagers” is generally used to mean a plurality of imagers. Said imagers may be of different brands or may include different elements such as processors and communication, or may be of different device types, or may include different lens locations, or may have different properties, or may be of different physical dimensions, or may be used with various accessories such as protective cases or ornamental cases, or may be connected with different devices.

The term “Sensor” is generally used to mean any software or hardware device or mechanical device or other device for getting information from the environment of the system or it may be combination of any of the above. Examples may be but are not limited to GPS, accelerometer, temperature sensor, magnetic fields detector, clock, and any of the like.

Various embodiments of the invention are now described in more detail:

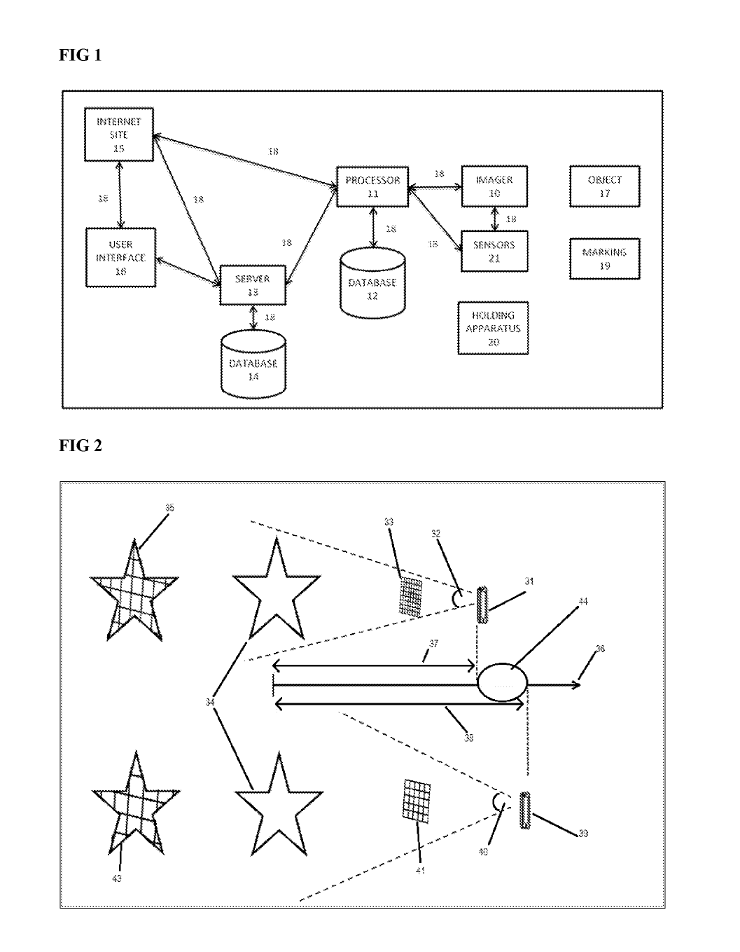

Referring to FIG. 1, a system is shown for monitoring subject data from object 17. The system includes an imager 10. The imager 10 is connected through communication 18 to a processor 11 which may be connected to a database 12. The processor 11 may be connected through communication 18 to a server 13 which may be connected to a database 14. Both server 13 and processor 11 may be connected to internet site 15 and may be connected to user interface 16. There may be more than one imager 10, processor 11, database 12, server 13, internet site 13 and user interface 16. Marking 19 may be placed on the object 17. A holding apparatus 20 may be used for holding the imager 10. Additional sensors 21 may be connected to the imager 10 or to the processor 11 or to both.

It should be noted that the monitoring system embodiment shown in FIG. 1 may be replaced or removed or adapted to different components or different connections between the components.

Further referring to the monitoring system embodiment shown in FIG. 1, it may be that some or all of the components may be included in the same device and it may be that each component will be included in a device of its own. For example it may be that the imager 10 and the processor 11 and the database 12 and the user interface 16 will be included in the same device, for instance a mobile phone. Another example is that also the server 13 and its database 14 are also included in the same mobile phone.

Further referring to the monitoring system embodiment shown in FIG. 1, it may be that not all of the components will be required in order for the system to function. For example the system can function without an internet site and without a user interface.

Further referring to the monitoring system embodiment shown in FIG. 1, it may be that each of the components may be a hardware component or a software component or a human or any combination of the above.

Further referring to the monitoring system embodiment shown in FIG. 1, the communication 18 may be of any of a variety of communication techniques, such as wireless or wired or the like or any combination of the above. Different communication lines may be of different technologies.

Further referring to the monitoring system embodiment shown in FIG. 1, its mode of monitoring may be that the imager 10 captures an image or images of the object 17, which may include marking 19 that are placed on the object 17 in the form of stickers or decals or any other marking 19. The imager 10 may be held in place by a holding apparatus 20. The image or images may be transferred to the processor 11. The processor 11 may perform image processing on the image or images, it may use data from the sensor 21, it may use data from the database 12 for that, it may use remote data from the server 13 or from the remote database 14 or combine data from any combination of the above. The processed data may be passed to the server 13, to an internet site 15, to user interface 16, to other components of the like or to any combination of the above.

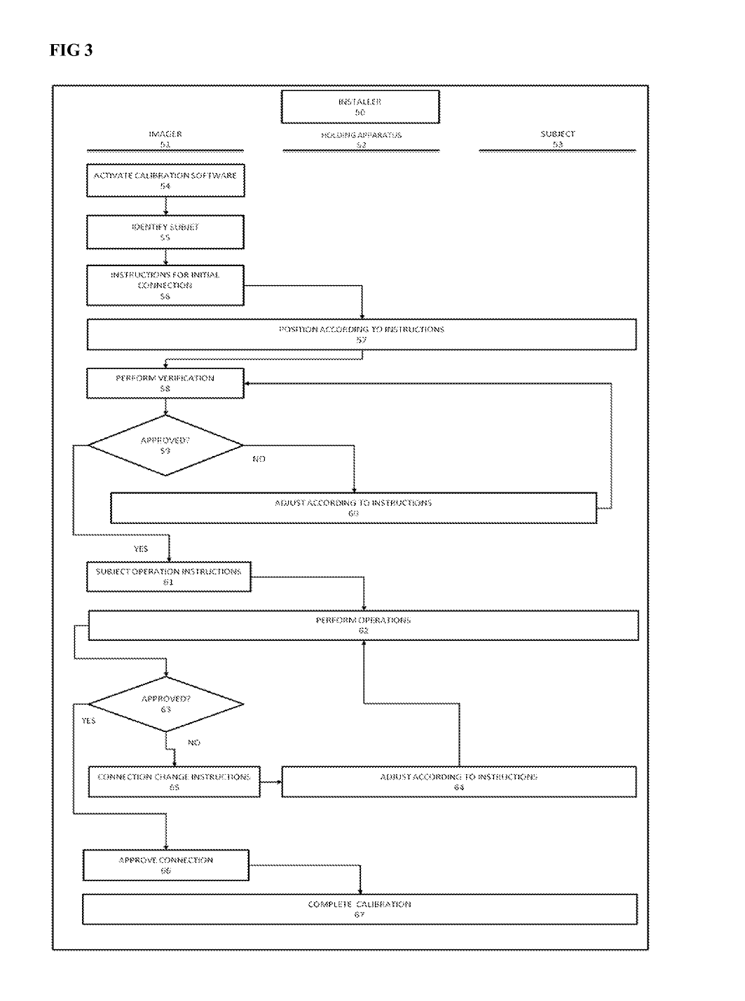

Referring to FIG. 2, an embodiment of the invention in which the properties of two different imagers 31 and 39 affect the resulting requirements from the range of distances 36 within which they should be place in order to properly monitor the subject 34. Imager 31 with FOV 32 and resolution 33 is used to perform image processing on subject 34, resulting in image 35. In order to view the entire subject 34, the imager 31 needs to be at a distance of 37 or more from the subject 34. At that distance 37 the resulting image 35 of subject 34 is in a specific resolution. Imager 39 with FOV 40 and resolution 41 is used to perform image processing on subject 34, resulting in image 43. In order to have sufficient resolution to perform image processing on the subject 34, imager 39 should be no farther from subject 34 than a distance of 38. At such a distance 38 the resulting image 43 is at the minimal accepted resolution.

Further referring to FIG. 2, in case of minimal specific image resolution 43 and different imagers 31 and 39 with different properties of FOV 32 and 40 and different properties of image resolution 33 and 41, and in case a single fixed holding apparatus needs to be used to hold the imager 31 and imager 39 in place, then the viable area 44 for a holding apparatus is between distance 37 and distance 38. Further, the holding apparatus may need to be positioned in a specific position and specific angle so that if imager 31 is used then subject 34 will be covered by its FOV 32, and in case imager 39 is used then subject 34 will be covered by its FOV 40.

Further referring to FIG.2, it shows an embodiment of the invention in which only imager 31 and imager 39 need to be supported. In an embodiment where the set of supported imagers contains a plurality of imagers then the viable area 44 for holding apparatus may be very limited or may not exist.

Further referring to FIG.2, it may be that the FOV property 32 of imager 31 and FOV property 40 of imager 39 are actually in 3 dimensions, which may make the calculation of the viable area 44 for holding apparatus more complex. It may also be that there are other objects in the vicinity of the subject 34 which may obstruct the FOV of the imagers 31 and 39 and further limit the viable area 44 for holding apparatus.

Further referring to FIG. 2, there may be more relevant properties of imager 31 or imager 39 which may affect the viable area 44 of the holding apparatus.

Further referring to FIG. 2, it may be that in order to calculate the viable area 44 for holding apparatus and in order to calculate the position and the angle in which supported imagers should be held by the holding apparatus, a processor with the necessary algorithm and data may be required. A processor which may use data from a database could use the properties of a first imager 31 such as resolution 33 and FOV 32 to find the current distance 37 of the imager 31 from the subject 34, use remote data on the properties of the other supported imagers and predict the viable area 44 for the holding apparatus so that each imager in the supported imagers would be able to receive an image of the subject 34 that satisfies the conditions for the required image processing.

Further referring to FIG. 2, it should be noted that the set of supported imagers may change with time. Since the subject processing data may be saved on the server or in a database, the viable area 44 for holding apparatus may be changed once the set of supported imagers is changed, so that the location of the holding apparatus can be changed.

Referring to FIG. 3, an embodiment of the invention in which a method comprised of calibrating of a holding apparatus 52 using an imager 51 so that said imager 51 and any of a supported imagers set will be able to perform monitoring on a subject 53. The method may be executed by an Installer 50.
The method may be comprised of any or some of the following steps:
The Installer 50 may activate calibration software 54.
The imager 51 may identify the subject 55.
The imager 51 may provide instructions for initial connection 56.
The Installer 50 may position according to instructions 57 the imager 51 or the holding apparatus 52, or both, the said position may be in relation to the subject 53.
The imager 51 may perform verification 58.
The imager 51 may indicate whether the position is approved 59 or not.
The Installer 50 may adjusted according to instructions 60 the holding apparatus 52, the imager 51 or the subject 53 or any combination of the above, which may result in a repeat perform verification 58.
Once approved 59, the imager 51 may provide subject operation instructions 61 to be performed on the subject 53.
The installer 50 may perform operations 62.
The imager 51 may check if data from the perform operations 62 is approved 63.
If data is not approved 63, the imager 51 may provide connection change instructions 65 for the holding apparatus 52, or the subject 53, or both.
The Installer 50 may adjust according to instructions 64 the holding apparatus 52.
It may repeat to perform operation on subject 62.
Once the imager 51 informs that approved 63, the imager 51 may approve connection 66.
At this point the installer 50 or imager 51 or holding apparatus 52 or subject 53 or any combination of the above may perform complete calibration 67 operations.

Further referring to the method of FIG. 3, the method of calibrating the system shown may be performed at any time. It may be performed on a system after it had already been calibrated, in order to provide better results or in order to support additional imagers 51. It may be performed by any installer 50.

Further referring to the method of FIG. 3, the activate calibration software 54 step may include the activation of a processor on the imager 51 or in the server. It may be performed manually or it may be performed automatically by the imager 51 or it may be a combination of both. For example the imager 51 may inform the system or it may inform the installer 50 that activating the software is required, or a GPS sensor may inform the installer 50 or it may initiate the process step itself.

Further referring to the method of FIG. 3, the identify subject 55 step may include identifying the type and instance of the subject 53. Identification may be done according to known properties or according to algorithm or using any method of identification or any combination of the above. This step may be performed by the installer 50 or it may be performed by the imager 51, or it may be performed using the imager 51 data or it may be performed using other sensor data such as GPS or by the installer 50, or by any combination of the above.

Further referring to the method of FIG. 3, the instructions for initial connection 56 may include instructions on how to place the holding apparatus 52, on how to place the imager 51, on whether to perform any action on the subject 53, on whether to perform any operation on the environment or any combination of the above. The instructions can be in written form or displayed form or in audio form or in any other form which may pass the data to the Installer 50 on how to connect the imager 51 or the holding apparatus 52 or both.

Further referring to the method of FIG. 3, the instructions for initial connection 56 may be specific to this imager 51 or to this holding apparatus 52 or to this subject 53 or to this installer 50 or to any combination of the above, or they can be general, or they can be skipped. For example it may be that the installer 50 is experienced and doesn't require the instructions.

Further referring to the method of FIG. 3, position according to instructions 57 may include adjusting the holding apparatus 52 or adjusting or placing the imager 51 or adjusting properties of the subject 53 or adjusting properties of the environment or any combination of the above.

Further referring to the method of FIG. 3, position according to instructions 57 may be performed on the imager 51, or on the holding apparatus 52 or on the subject 53 or on any combination of the above or on none. For example the holding apparatus 52 may be placed in a specific distance from the subject 53 and at a specific angle in relation to the subject 53, and the imager 51 may be placed on the holding apparatus 52.

Further referring to the method of FIG. 3, perform verification 58 may include the imager 51 taking images and may include performing image processing on said images, and may include comparing the details in the raw data or the process data from the images to expected criterions.

Further referring to the method of FIG. 3, perform verification 58 may be done according to any data available to the imager 51, such as image data, sensor data, data known by the installer 50 or any other data relevant to the decision or any combination of the above. For example the size of the subject 53 in the image along with GPS data on the location of the imager 51 and data on the time of day may be used to determine if the raw data in the image is sufficient.

Further referring to the method of FIG. 3, approved 59 may be determined by any criteria posed on any of the properties of the data available to the imager 51.

Further referring to the method of FIG. 3, the adjust according to instructions 60 step may include adjusting the location of the holding apparatus 52 or adjusting the position of the imager 51 or adjusting any other properties of either of the system elements.

Further referring to the method of FIG. 3, the adjust according to instructions 60 may be performed on the imager 51, or the holding apparatus 52, or the subject 53, or on other elements such as environment elements, or on any combination of the above. For example the imager 51 may need to be adjusted to be held differently by the holding apparatus 52.

Further referring to the method of FIG. 3, the subject operation instructions 61 may include orders on how to make operations on the subject 53 which may provide more data on an ability to perform monitoring on the subject 53.

Further referring to the method of FIG. 3, the subject operation instructions 61 may be used in order to simulate the image processing required for monitoring, or it may be required to perform verification on any of the parameters of the subject 53, or it may be used in order to get more data on the subject 53, or on its environment, or on the imager 51, or on any relation between the above or any combination of the above. The subject operation instructions 61 may be in any form such as written form or diagram form or voice instructions or communication protocol or any similar way to provide instructions, or any combination of the above. The instructions may also include adding elements to the subject 53, or to the environment. For example if the subject 53 is a weights machine in a fitness room the subject operation instructions 61 may be to perform repetitions with a given weight and to mark the machine with a specific marker at a specific location.

Further referring to the method of FIG. 3, the perform operations 62 step may include operations on the imager 51 or on the holding apparatus 52 or on the subject 53 or on the environment of the system or on any combination of the above. Such operations may be physical operations, or mechanical operations, or digital operations, or any combination of the above. The imager 51 may be used to perform monitoring of the operations in order to receive all data necessary. For example the perform operations 62 may be to open a door, or to open a window in the area of the subject.

Further referring to the method of FIG. 3, the approved 63 step may be performed by the imager 51 or by the installer 50 or by a remote party or by any combination of the above. It may be done according to predefined criteria or it may be done according to deduced criteria. For example, in a fitness facility the approved 63 may check if the entire weight movement range is included in the FOV of the imager 51.

Further referring to the method of FIG. 3, the connection change instructions 65 may include instruction on how to change the properties of the holding apparatus 52 or the imager 51 or the subject 53 or any combination of the above.

Further referring to the method of FIG. 3, the connection change instructions 65 may be provided in visual display or in voice or in diagrams or in communication protocol or in any other method for passing instructions or in any combination of the above. It may include instructions regarding the subject 53 or regarding the holding apparatus 52 or regarding the imager 51 or any combination of the above. For example it may be to change the position of the holding apparatus 52 by 5 cms to the north.

Further referring to the method of FIG. 3, the adjust according to instruction 64 step may be performed by any installer 50 or it may be performed automatically or it may be performed mechanically or any combination of the above. For example the holding apparatus 52 may include mechanisms to adjust its location without any action by the installer 50. For another example the installer 50 may lock the holding apparatus 52 in place. For another example the holding apparatus 52 may be replaced with a simpler holding apparatus 52 whose properties are fixed. For another example in a fitness facility where the subject 53 is a digital cardiovascular training machine, the adjust according to instructions 64 may be to activate it in a specific mode or to activate a specific functionality.

Further referring to the method of FIG. 3, the approve connection 66 step may be used to inform all relevant elements that the calibration is approved.

Further referring to the method of FIG. 3, the complete calibration 67 step may be used to perform operations on all components.
The imager 51 may save the data or it may upload the data to server or it may print the data or it may report the data by voice, or by visual output, or by any other means of communicating the data, or by combination of the above.
The holding apparatus 52 may be locked, or its properties may be registered or its picture may be taken, or it can be removed, or additional parts may be added to it, or it can be replaced with a different holding mechanism, or a marking may be done on it, or any combination of the above. For example additional parts in specific colors or shapes may be connected to the holding apparatus 52 in order to make it more fitting for the environment.
For another example in a fitness center, a colored plastic cover in colors matching those of the fitness facility and with the fitness center's logo may be added to the holding apparatus 52 in order to make it fit its surroundings.
The subject 53 may be marked by a color or a sticker or any other way, or data can be input to it or any other operation can be done on it. For example in a fitness facility where the subject 53 is a digital cardiovascular machine, data provided from the imager 51 such as digital ID may be inputted into the cardiovascular machine in order to connect it with the system.
The environment of the subject 53, or of the holding apparatus 52 may be changed or adapted or recorded or any of the above, for example a window can be closed and secured or a marking made be made on the walls.

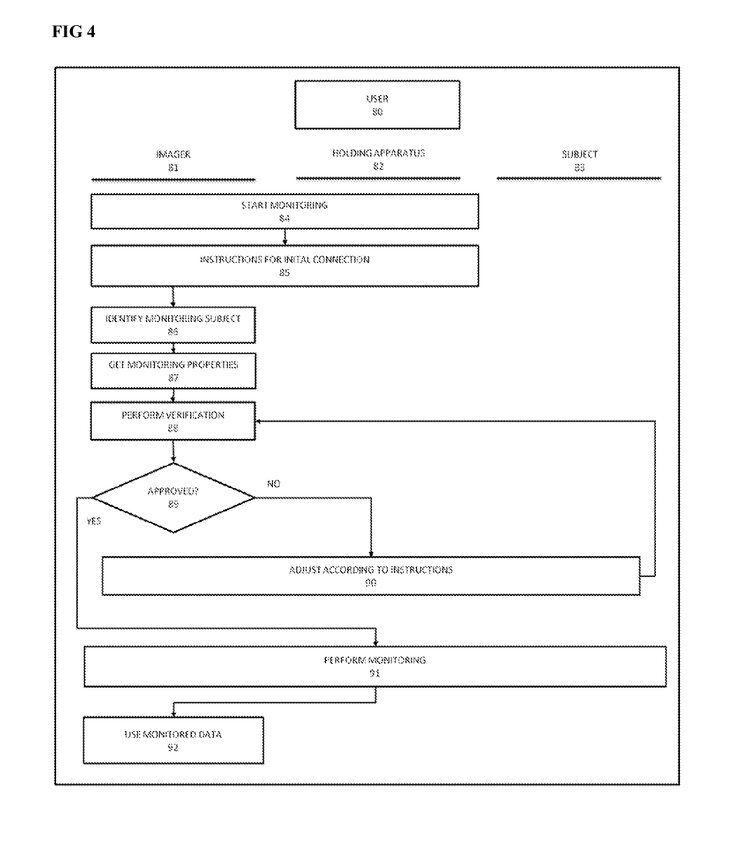

Referring to FIG. 4, an embodiment of the invention is which a method comprised of using a holding apparatus 82 and an imager 81 so that said imager 81 and any of a supported imagers set will be able to perform monitoring on a subject 83.
The method may be executed by a user 80.
The method may be comprised of any or some of the following steps:
Start monitoring 84.
Instructions for initial connection 85.
Identify monitoring subject 86.
Get monitoring properties 87.
Perform verification 88.
Check if position is approved 89.
Adjust according to instructions 90.
Perform monitoring 91.
Use monitored data 92.

Further referring to the method of FIG. 4, the method of using the system shown may be performed at any time. It may be performed on a system after it had already been calibrated or it may be used without the system being calibrated. It may be used by any user 80, human or mechanized or automatic or any combination of the above.

Further referring to the method of FIG. 4, the method of using the system shown may be performed using any imager 81, of any type and with any properties. It may be used by an imager 81, different than the imager 81, using which the system was calibrated. For example the system may be calibrated using a smart-phone of brand X and used by a music player of brand Y.

Further referring to the method of FIG. 4, the start monitoring 84 step may include activating the monitoring software or hardware or both.

Further referring to the method of FIG. 4, the start monitoring 84 step may be performed manually or it may be performed automatically by the imager 81, or it may be a combination of both. For example the imager 81, may inform the system or it may inform the installer 80 that activating the software is required, or a GPS sensor may inform the installer 80, or it may initiate the process step itself

Further referring to the method of FIG. 4, the instructions for initial connection 85 step may consist of instructions for the user 80 on how to position the imager 81 in order to start monitoring. The imager 81 may be placed on the holding apparatus 82 or may not. It may be placed in relation to the subject 83 or it may not. Providing the instructions may be performed automatically by the imager 81, or it may be requested by the user 80, or it may be a combination of both. The instructions can be in written form, or they can be in displayed form, or they can be in audio form, or they can be by communication protocol, or they can be in any other form which may pass the data to the user 80 on how to connect the imager 81. For example the imager may inform the system, or it may inform the user 80 that activating the software is required, or a GPS sensor may inform the user 80, or it may initiate the process step itself.

Further referring to the method of FIG. 4, the identify monitoring subject 86 step may include activating the monitoring software or hardware or both. It may include identifying the type or the instance of the subject 83. Identification may be done according to known properties, or it can be done according to algorithm, or it can be done using any method of identification, or any combination of the above. This step may be performed manually, or it may be performed by the imager 81, or it may be performed using the imager's data, or it may be performed using other sensor data such as GPS, or it may be performed by the user 80, or by any combination of the above.

Further referring to the method of FIG. 4, the get monitoring properties 87 step may include getting the properties required for monitoring from memory, or from server, or from the user 80, or from a processor operation, or from any combination of the above. The properties required for monitoring may include but are not limited to the properties of the imager 81, the properties of the holding apparatus 82, the properties of the subject 83, or any other properties that are relevant to the monitoring task. For example the monitoring properties may be found by getting data from memory on the type of imager 81, and information on the type of subject 83, followed by the processor using this information within an algorithm, and determining the properties required for monitoring, such as frame rate.

Further referring to the method of FIG. 4, the perform verification 88 step may include taking an image or images by the imager 81, passing it to the processor, activating image processing on said image or images. It may include verifying that the resulting processed data satisfies the monitoring requirements. For example performing verification may take an image of the subject 83, process it and find the exact color of a certain parameter of the subject 83.

Further referring to the method of FIG. 4, the perform verification 88 step may be performed by the user 80, or by the imager 81, or by another entity, or by any combination of the above. For example the imager 81 may request the user 80 to input some details regarding the subject for verification.

Further referring to the method of FIG. 4, the checking if approved 89 step may include comparing the verification results found in perform verification 88 with expected values from memory, or from server, of from user 80, and approve only if said results are in a specific relation to the expected results. For example the imager 81 may compare the found color of a specific parameter of the subject 83 and approve only if this color is in a pre-specified range around an expected color.

Further referring to the method of FIG. 4, the checking if approved 89 step may be performed by the imager 81, or it may be performed by the user 80, or it may be performed by a remote entity such as a server, or it may be performed by any combination of the above. For example the imager 81 may determine a grade of closeness and the user 80 may be requested to approve it or not.

Further referring to the method of FIG. 4, the adjust according to instructions 90 step may include making changes to the imager 81, or making changes to the holding apparatus 82, or making changes to the subject 83, or making changes to the environment, or making changes to any combination of the above. It may be that the requested adjustments will increase the chance that the verification will be approved 89. The instructions may be provided by the imager 81, or they can be provided by the user 80, or they can be provided by another entity, or by any combination of the above. The instructions may be provided in any form including but not limited to voice orders, graphical schemes, displayed sentences, communication protocol and the like, or any combination of the above. For example the imager 81 may instruct the user 80 to adjust the holding apparatus 82 so that the imager 81 is aimed 2 degrees higher, and the imager 81 may also configure itself to use a higher frame rate.

Further referring to the method of FIG. 4, the perform monitoring 91 step may include monitoring the subject 83 using the system.

Further referring to the method of FIG. 4, in the perform monitoring 91 step the imager 81 may take an image or images or use a variety of image taking techniques. The imager 81 may use only local data, or it may use data from the server, or it may use data from the user 80, or it may use data from other sources, or it may use any combination of the above. It may also use the monitored data, or it may send it to server, or it may display it to the user 80, or it may use it in any other way, or it may use it in any combination of the above. For example when the subject 83 is a weights machine in a fitness facility and the monitoring counts the weight lifting repetitions, the imager 81 may inform the user 80 on count using audio and it may update a remote server on progress.

Further referring to the method of FIG. 4, in the perform monitoring 91 step the holding apparatus 82 may be fixed or some of its elements may be in motion or some other properties of it may change, such changes may be performed by the user 80, or by the holding apparatus 82 itself. For example the holding apparatus 82 may have mechanics that allow it to change the horizontal angle of the imager 81 placed on it to track a horizontal motion of the subject 83.

Further referring to the method of FIG. 4, in the perform monitoring 91 step the subject 83 may be mobile or it may be static, it may be used by the user 80, or it may not. Some of its properties may change or some properties may be constant. The environment of the subject 83 may also be static or dynamic. For example when monitoring an outdoor sports activity the subject 83 may be an athlete running in the FOV of the imager 81 so the subject's position changes, and the environment may be outdoors so the lighting may change.

Further referring to the method of FIG. 4, the use monitored data 92 step may include the imager 81 using the processed data, or using other properties of the subject 83, or using properties of the holding apparatus 82, or using properties of the imager 81, or using properties of the environment, or any combination of the above, in order to analyze the data or to save it for future use, or in order to use it in any other way, or any combination of the above. For example the lighting conditions on the subject 83 can be sent to server for use by the next imager 81 that will monitor this subject 83.

Referring to FIG. 5, an embodiment of the invention is which the system is used to monitor a weight stack machine 100 is shown. The imager 103 is placed on a holding apparatus 102 which is connected to the machine 100. The imager's FOV 101 covers a portion of the machine 100. Markers 105 are placed on the weights 104. The user 106 may have marking 107 on his person. There may be marking 108 on the machine 100.

Further referring to the system embodiment of FIG. 5, the imager 103 in use may be a smart-phone of the user 106, or it can be any imager 103 provided by the fitness facility. The imager 103 may be static—fixed to the machine, or it may be dynamic—where each user 106 will place an imager 103 of their own.

Further referring to the system embodiment of FIG. 5, the raw data may be the image of any section of the machine 100, or an image of the entire machine 100, or an image of the user 106, or any combination of the above. The processed data may include the weight of the weights 104 being lifted, or it may include the height to which the weights 104 are lifted, or it may include the speed with which the weights 104 are lifted, or it may include the number of repetitions, or it may include the number of sets, or it may include the rest time between repetitions, or it may include the lighting parameters at each height of weights 104, or it may include any similar data, or any combination of the above.

Further referring to the system embodiment of FIG. 5, the holding apparatus 102 may be connected to the machine 100, or it may be connected to the floor, or it may be connected to the ceiling, or it may be connected to another object in the area, or it may be held by a person, or it can be connected or held by any combination of the above.
The holding apparatus 82 may be connected so that the FOV 101 of the imager 103 will cover the range of movement of the weights 104, or so it can cover the user 106 of the machine 100, or so that it can cover an additional object in the area, or that it can cover any combination of the above.
The location or calibration of the holding apparatus 102 may be set using a calibration process as described in FIG.3, or it may be set using a different process or it may be set arbitrarily.
The holding apparatus 102 may also be dynamic, in the sense that the user 106 can move it so that the FOV of the imager 103 covers the area preferred by the user 106.
For example the holding apparatus 102 may be calibrated by the user so that it is connected to the floor and so that the FOV of any imager 103 placed on it will include both the weighs 104 and the user 106.

Further referring to the system embodiment of FIG. 5, there may be markings 108 on the machine 100, or there may be marking 105 on the weights 104, or there may be marking 107 on the user 106, or any combination of the above. The marking may be used to simplify the monitoring of the exercise.
For example the marking 105 on the weights 104 may be of a unique color which simplifies the counting of weights 104, and marking 108 may be a QR-code which simplifies the identification of the machine 100.

Further referring to the system embodiment of FIG. 5, it may be that in such a case, the holding apparatus 102 may be calibrated using the calibration process of FIG. 3 using a single imager 103.
It may also be that every user 106 that uses the machine 100 can use their own imager 103 in order to monitor their exercise using the process of FIG. 4.
It may be that monitoring the exercise is done by calculating the number of weights 104 moved at every image, or by calculating the height of the moved weights 104 at every image, or by calculating the position of the user 106 at every image or any combination of the above.
It may be that the processed data is used to provide the user 106 immediate feedback such as voice or displayed data, or that the data is sent to a fitness specialist. It may be that upon identifying the machine 100, the imager 103 gets the data on the properties of the exercise to perform and notifies the user 106 of the specific properties of how to perform the exercise.
It may be that the imager 103 processes the data and determines whether the exercise is performed correctly, and notifies the user 106, or notifies another person, or notifies another entity, or any combination of the above.
It may be that the system detects that calibration is needed and informs any of the users 106 of that.
It may be that the imager 103 can receive from a server the properties of the area, or the properties of the machine 100, or the properties of the holding apparatus 102, or other properties relevant to the monitoring of the machine, or any combination of the above. It may be that receiving the subject processing data for monitoring is done before the user 106 arrives at the machine 100, or once the user 106 arrives at the machine 100. It may be that the entire subject processing data relevant to the user 106 is saved to the imager 103 once the user 106 registers to a fitness facility, or it may be that this data is received by the imager 103 only upon demand.

Further referring to the system embodiment of FIG. 5, it may be that the imager 103 is a fixed imager 103 which remains connected to the holding apparatus 102 and aiming at the machine 100 at all time. It may be that in such a case, when no user 106 is using the machine 100, the imager 103 is used to display other data. It may be that in the case of a fixed imager 103, any user 106 using the machine 100 may need to login to the imager 103 so that the imager 103 will be able to connect the processed data to its user 106.
It may be that a fixed imager 103 is used without identifying the user 106, using the processed data for statistics, or for fitness facility data analysis, or for any other purpose possible with the data, or for any combination of the above.

Further referring to the system embodiment of FIG. 5, it may be that in the calibration process of FIG. 3, the calibration includes performing repetitions with the weights 104 so that the imager 103 can save the lighting parameters at different weights 104 height. It can also be that the marking 108 on the machine 100, or the marking 105 on the weights 104 are placed and approved by the calibration process.

Further referring to the system embodiment of FIG. 5, it may be that the fitness room exercise machine may be any machine is the fitness room such as a cardiovascular exercise machine, or a free weights area, or a hydraulic machine or any other type of fitness exercise.
In the case of a cardiovascular machine the holding apparatus 102 may be placed so that the FOV 101 of the imager 103 includes the cardiovascular machine's screen, in which case the imager 103 may monitor the data displayed on the screen.
In the case of free weights it may be that the holding apparatus 102 may be connected to the wall or connected to the ceiling or connected to the floor, in such a way that the FOV 101 of an imager 103 placed on it will include the user 106. In such a case the monitoring may include locating the free weights and analyzing their movement. In such a case marking could be placed on the free weights to simplify the monitoring.

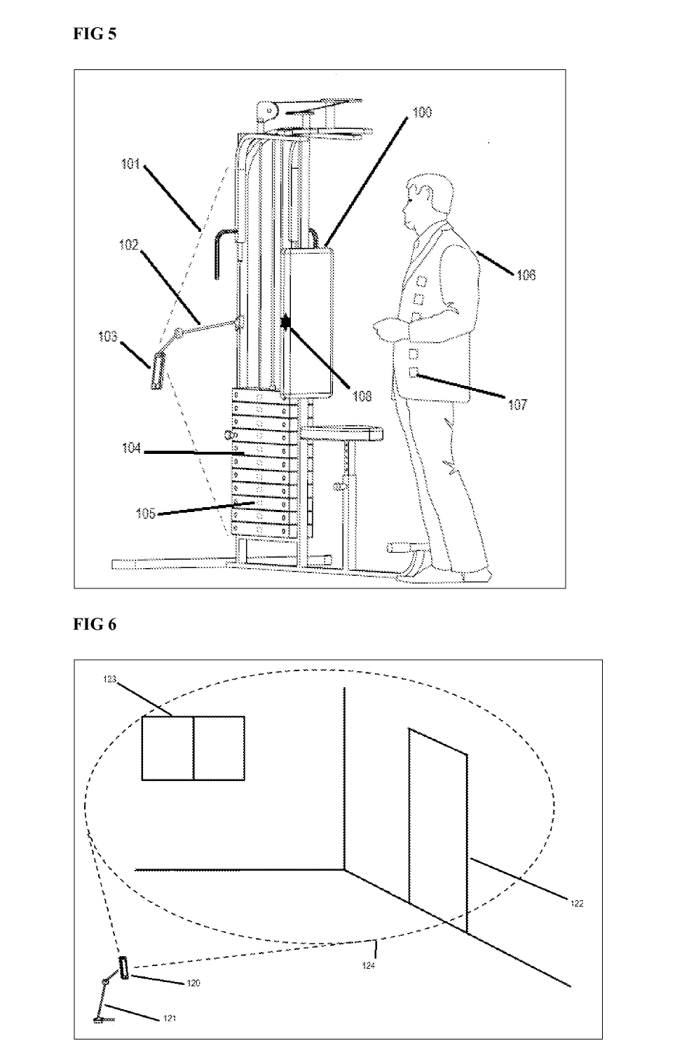

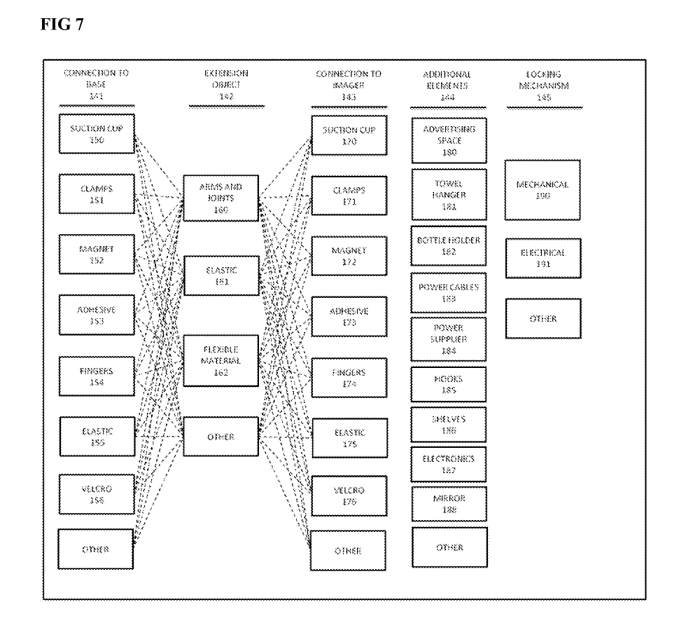

Referring to FIG. 6, an embodiment of the invention is shown in which the system is used to monitor a hotel room, for example for safety purposes. There is shown an imager 120 placed on a holding apparatus 121, the FOV 124 of the imager 120, and the hotel room door 122 and window 123.

Further referring to the system embodiment of FIG. 6, it may be that the monitoring is used to identify whether the door 122 or the window 123 is opened at a specific time. It may be that the holding apparatus 121 is fixed in place and it may be that it is free to be adjusted by a user. For example it may be used at night to alert from burglars.

Further referring to the system embodiment of FIG. 6, it may be that the calibration process described in FIG. 3 may be performed so that the holding apparatus 121 is affixed so that for any imager 120 placed on it, the FOV 124 of the imager 120 will cover both the door 122 and the window 123. It may be that the operations on the subject performed at calibration may be to close the light in the room, or to open the door 122, or to open the window 123, or to perform another operation which may be used to affect images taken by the imager 120, or any combination of the above. It may be that any guest receiving a room will be able to connect their imager 120 to the system, get the data required for image processing in their specific room, and use their imagers for safety.

In another embodiment of the system, a holding apparatus may be installed for spectators in a sports event such as a football match. The system is calibrated so that for every imager placed on the holding apparatus, the FOV covers the sports field, and it may be that the server is updated with the details of the competing teams such as the colors of the uniforms and the names of the players registered for the match. It may be that the subject processing data includes all the data to allow the imager to track the occurrences in the match. It may be that monitoring the match will enable the user to receive from the imager any data regarding the match.
In this embodiment of the system it may be that any number of holding apparatuses are connected once and calibrated once using a single imager, so that any user with any imager could receive the data.
It may be that a very similar system would be installed for theater spectators, providing data on the show, the actors and any other data required.

For example it may be that the user will place their imager in the holding apparatus, the imager will identify the time, date and location. Then the imager downloads from a server the relevant data on the teams playing. Then throughout the sports match the imager is able to provide any data to the user that the user request, including length of shot, how close was a missed shot, how many miles any player ran and so forth.

In another embodiment of the system, a holding apparatus may be installed in an athletes' training facility, such as a high jump or a jump horse arena.
In such embodiment the system can be installed once and calibrated once using a single imager, so every imager placed in the holding apparatus will be able to use monitoring to analyze the performance of the athletes practicing or competing. It may be that after such calibration, every athlete or athletics instructor or journalist or spectator will be able to use their own imager to receive data on the athlete's performance.
For example it may be that a high jump instructor will use the system with each athlete's imager to track the results and the statistics of the various athletes, to use monitoring to determine parameters of their performance such as the jump height, the running speed etc. and to analyze and present this data to whoever can assist the training.

In another embodiment of the system, a holding apparatus may be installed in a clothes store, to be used for assessing the fit of the clothes to the users. The calibration process may enable any imager to receive a full view of the person using the system, and save the lighting conditions, the user may try on some clothing and may use the monitoring to assess the fit, or to assess the color balance, or to assess any other quality of the clothes, or to identify the code of the clothes for later decision. The data could then be used to save the clothes' details and be used by the user.
For example the user may use the system to simulate for specific clothing how the same model clothing with different colors would look on them. The imager monitors the image and finds the clothing's store code, and analyzes the lighting to determine the store's effect on the appeared color of the clothing, and then processes the data and displays how the same clothing would look outside the store in natural lighting and how the same model with a different available color will look.

In another embodiment of the system, a holding apparatus may be installed in a bowling alley, to be used for monitoring the bowling results.
In such embodiment, the holding apparatus will be calibrated using a single imager so that any user playing bowling will be able to place their imager once their turn arrives, so that their imager will be able to monitor their shots. Monitoring could then calculate the result, save the movies of the shots for any use, share the shots, provide statistics and professional advice, etc.
In such embodiment since every player may have a different imager, the ability to place different imagers so that each will be able to perform monitoring is valuable.
In a similar fashion, the system can be used in a snooker hall or for any other sports where players take turns in playing.

Referring to FIG. 7, a possible embodiment of the holding apparatus is shown. The holding apparatus may include a connection to base 141 which may be an element for placing or affixing the apparatus itself in a specific or arbitrary position. The connection may be to a floor, or to a wall, or to a ceiling, or to a machine, or to a person, or to a moving object, or to any other element that provides a dynamic or static position, or to any combination of the above. The connection to base may include a vacuum suction cup 150, or it may include clamps 151, or it may include magnet 152, or it may include adhesive 153, or it may include fingers 154, or it may include elastic 155, or it may include Velcro 156, or it may include any other element that allows positioning an object in place or any combination of the above.

Further referring to the embodiment of the invention of FIG. 7, the holding apparatus may include a connection to imager 143 which may be used to hold or position the imager in a specific or arbitrary position and a specific or arbitrary angle, which may be in relation to the subject or in relation to any other object. It may be of any form or include any mechanism that allows an imager to be placed on it, connected to it, coupled to it or any other way of creating a physical relation between the Connection to Imager and the imager, or any combination of the above. The Connection to Imager may include a vacuum suction cup 170, or it may include clamps 171, or it may include magnet 172, or it may include adhesive 173, or it may include fingers 174, or it may include elastic 175, or it may include Velcro 176, or it may include any other element that allows positioning an object in place, or it may include any combination of the above. The Connection to Imager 143 may include a means for affixing it into place and may include a mechanism for releasing said affixation.

Further referring to the embodiment of the invention of FIG. 7, the holding apparatus may include an extension object 142 which may be used to allow positioning the connection to imager 143 in any desired position in relation to the connection to base 141.
It may be of varying length. It may be of varying materials. It may be of varying elasticity.
It may be a single object or it may be a mechanism. It may be fixed or it may be dynamic.
It may include arms and joints 160, or it may include elastic 161, or it may include flexible material 162, or it may include any elements that may connect the connection to base with the connection to imager, or it may be any combination of the above.

Further referring to the embodiment of the invention of FIG. 7, the holding apparatus may include additional elements 144 such as advertising space 180, towel hanger 181, water bottle holder 182, power cables 183, power supplier 184, hooks 185 for hanging, shelves 186 for placing personal belongings, electronics 187 such as screens and communication ports, mirror 188, or any other element which may assist the user of the holding apparatus when using the holding apparatus, or any combination of the above.

Further referring to the embodiment of the invention of FIG. 7, the holding apparatus may have a locking mechanism 145, which may enable a user to secure the holding apparatus or any element of it so that it does not move. It may include an unlocking mechanism for releasing the affixation. It may enable multiple locking and releasing. The locking mechanism 145 may be mechanical 190 or it can be electrical 191 or it can be of any other technology that allows locking into place, or it can be any combination of the above.

Further referring to the embodiment of the invention of FIG. 7, the holding mechanism may be of any color and any material. It may include elements that can be replaced or adapted or added so that its appearance may be adapted to its location or its user or for any other purpose or any combination of the above. Examples for such use are a cloth or plastic sleeve in specific colors or shape.

It should be understood that the above is merely exemplary, and that the form of the system may vary widely between embodiments.

It will be understood that the above description of the present invention is susceptible to various modifications, changes and adaptations, and the same are intended to be comprehended within the meaning and range of equivalents of the appended claims.

It will be understood that the above description of “Monitoring System Accommodating Multiple Imagers” has been with respect to particular embodiments of the invention. While this description is fully capable of attaining the objects of the invention, it is understood that the same is merely representative of the broad scope of the invention envisioned, and that numerous variations of the above embodiments may be known or may become known or are obvious or may become obvious to one of ordinary skill in the art, and these variations are fully within the broad scope of the invention. For example, while certain wireless technologies have been described herein, other such wireless technologies may also be employed. Furthermore, while various types of fitness machines have been mentioned, numerous other types may also be used in the embodiments of the invention. Accordingly, the scope of the invention is to be limited only by the claims appended hereto, and equivalents therefore. In these claims, a reference to an element in the singular is not intended to mean “one and only one” unless explicitly stated. Rather, the same is intended to mean “one or more”. All structural and functional equivalents to the elements of the above-described preferred embodiment that are known or later come to be known by those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present invention is intended to be dedicated to the public regardless of whether the element, component or method step is explicitly recited in the claims.

What is claimed is:

1. A system, comprising:
A holding apparatus to hold an imager in a position and at an angle relative to a subject;
A memory to store a plurality of parameters of a plurality of imagers;
A processor to
determine whether an image of said subject captured with a first imager of said plurality of imagers, said first imager held in said holding apparatus, satisfies a plurality of conditions for a view of said subject; and
determine using a first parameter of a second imager of said plurality of imagers, said first parameter stored in said memory, whether an image of said subject captured by said second imager when held in said holding apparatus at said position and said angle would satisfy said plurality of conditions of said view of said subject.

2. The system as in claim 1, wherein said subject comprises an object, said object, to appear in said image of said subject captured with said first imager of said plurality of imagers, and wherein image data of said object is stored in said memory.

3. The system as in claim 1, wherein said holding apparatus comprises a mechanism to secure said position and said angle.

4. The system as in claim 1, wherein said holding apparatus comprises an adjustable cradle, said cradle suitable to hold any of said plurality of imagers at said position and said angle.

5. The system as in claim 1, wherein said subject is an exercise machine.

6. The system as in claim 1, wherein said system is used for monitoring of sports activities.

7. The system as in claim 1, wherein said system is used for monitoring a theater.

8. The system as in claim 1, wherein said system is used for monitoring clothes in a store.

9. The system as in claim 1, wherein processor and memory are remote from said imager.

10. A method of calibrating a position of a device to hold an imager of a plurality of imagers, said method comprising:
positioning said device in a first position and first angle relative to a subject;
determining whether an image captured by said imager held by said device at said first position and first angle, satisfies a plurality of pre-defined conditions for said image of said subject;
evaluating a plurality of characteristics of each of said plurality of imagers, said characteristics stored in a memory, to determine whether images of said subject captured by each of said plurality of imagers when held in said device would satisfy said plurality of pre-defined conditions; and
adjusting said position and said angle to a second position and second angle wherein images captured by each of said plurality of imagers when held in said device at said second position and second angle satisfy said plurality of conditions.

11. The method as in claim 10, comprising moving a component of said subject.

12. The method as in claim 10, wherein said subject comprises a display screen, and further comprising altering a size of data displayed on said display screen.

13. The method as in claim 10, wherein said subject is an exercise machine.

14. The method as in claim 10, wherein said plurality of conditions is determined by remote server.

15. The method as in claim 10, wherein the method comprises locking said device in said second position and said second angle.

16. The method as in claim 10, wherein the method comprises storing in a memory parameters of said adjusting
